(19) United States
(12) Patent Application Publication
(10) Pub. No.: US 2010/0005713 A1
(43) Pub. Date: Jan. 14, 2010

(54) Pest repelling tree collar devise for keeping pests away from trees & plants

(76) Inventor: Paul Swart, San Jose, CA (US)

Correspondence Address: Paul Swart, 3470 Canyon Creek Dr., San Jose, CA, 95132, US

(21) Appl. No.: 12/217,722

(22) Filed: Jul. 9, 2008

(51) Int. Cl. A01G 13/10

(52) U.S. Cl. 47/32.5

(57) ABSTRACT

A device is described for repelling pests from fruit and other trees as well as certain plants. The device consists of an adjustable collar that is strapped tight around the tree trunk, tree branches or plant stem. The collar consists of a liquid absorbing foam strip and a tying mechanism such as a pipe clamp, or Velcro strap. To be most effective, the foam strip should completely surround the tree trunk or plant stem so as to not allow any way of passage for ants and other tree-crawling pests to make it through the repelling barrier without having to crawl over it. A repellant or insecticide is poured on top of the collar's foam strip. Thus a repelling barrier is created that crawling pests will not cross or that causes a repelling aroma to engulf the tree or plant and which repels flying insects.

### BACKGROUND OF THE INVENTION

Anyone with fruit trees in their yard knows the agony of seeing entire colonies of ants or other pests overtaking the trees and devouring much of their fruit or causing deceases. While there are insecticides and repellants available that can be sprayed onto the tree, most people are uncomfortable eating fruits from trees sprayed with such chemicals.

The device described in this patent application effectively keeps pests sensitive to repellants and other insecticides away from trees and certain plants.

### SUMMARY OF THE INVENTION

This invention provides a simple, highly scalable devise for keeping pests away from fruit and other trees and certain plants. The invention consists of an adjustable repellant/insecticide-impregnated collar that is strapped around the trunk of the tree. The collar repels tree-crawling pests below the color and traps those above the collar, causing most of them to abandon the tree or expire as they attempt to escape the tree by crossing the collar. The collar can also be used to repel flying pests by emanating a repellant odor.

### BRIEF DESCRIPTION OF THE DRAWINGS

FIG. 1 is a top view of Tree Collar strapped around a tree trunk with a pipe clamp

FIG. 2 is a top view of Tree Collar strapped around a tree trunk with a Velcro strap

FIG. 3 is a cross view of the Tree Collar when strapped to a tree truck

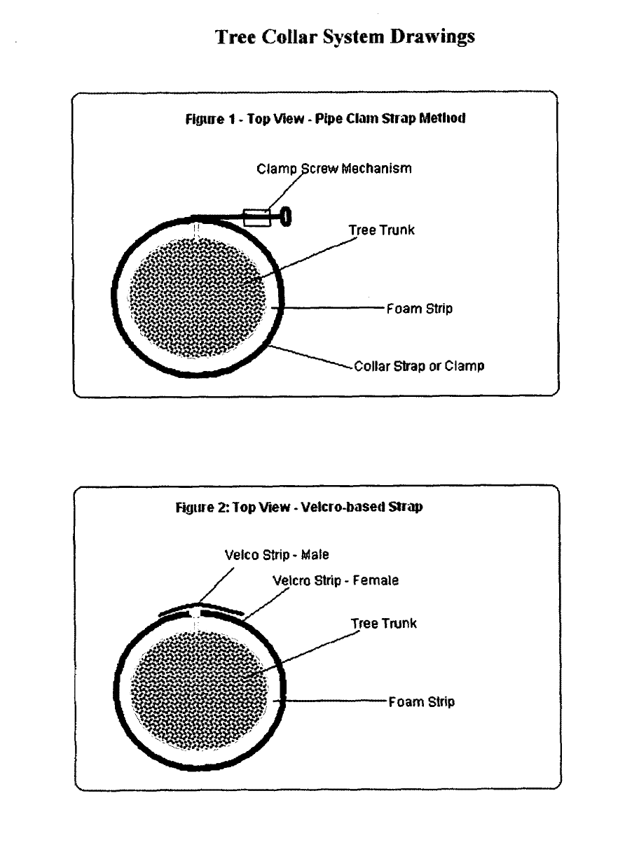

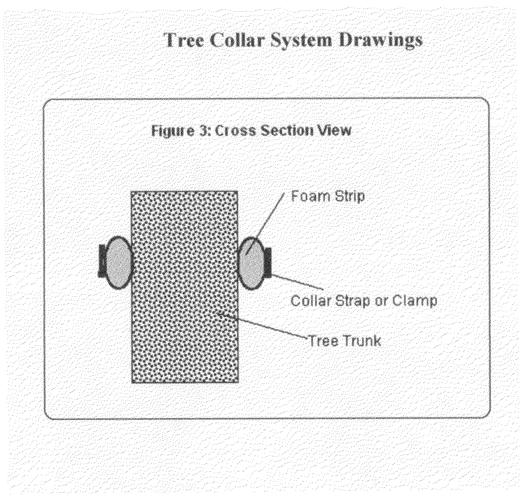

### DETAILED DESCRIPTION OF SPECIFIC EMBODIMENTS

Following is a detailed description of the operation of the system in two embodiments.
1. FIG. #1 shows how the device is strapped to the trunk of a tree using an adjustable pipe clamp. A liquid-absorbing foam strip is wrapped around the trunk of a tree. The foam strip is held in place by a screw-based pipe clamp. The strap is tightened by turning the clamp screw. A repellant/insecticide is applied at the top of the foam strip. The repellant is absorbed into the strip, creating a repelling barrier that will likely retain its effectiveness for about as long as the repellant manufacturer's claim of how long the repellant remains effective. If needed, the collar can be re-impregnated for extended effectiveness.
2. FIG. 2 shows how the device is strapped to the tree trunk using a Velcro-type strip. The Female part of the Velcro Strap is attached to the foam strip. The strap is cut to the size of the tree trunk, then tightly wrapped around the tree trunk with the female Velcro strip pointing outward. The two ends of the strap are secured with a male strip of Velcro. The repellant/insecticide is then applied at the top of the foam strip. The repellant is absorbed into the strip, creating a repelling barrier that will likely retain it effectiveness at least as long as the repellant manufacturer's claim of how long the repellant remains effective. If needed, the collar can be re-impregnated for extended effectiveness.

What is claimed:

1. A device for repelling tree-crawling pests from climbing into fruit trees, other trees and certain plants by strapping a repellant-impregnated collar around the tree trunk or plant stem.

2. A device for repelling flying pests from fruit trees by strapping a collar that emanates a repellant odor around the tree truck, tree branches or plant stem.
